(19) United States
(12) Patent Application Publication
(10) Pub. No.: US 2008/0271794 A1
(43) Pub. Date: Nov. 6, 2008

(54) Automated mechanical constant flow valve for air ducts

(76) Inventor: Louis Leemhuis, Hendersonville, NC (US)

Correspondence Address: RUSSO & DUCKWORTH, LLP, 2nd Floor, 9090 Irvine Center Drive, Irvine, CA, 92618, US

(21) Appl. No.: 12/150,491

(22) Filed: Apr. 29, 2008

Related U.S. Application Data
(63) Continuation-in-part of application No. 11/799,410, filed on May 1, 2007.

(51) Int. Cl. F16K 17/04

(52) U.S. Cl. 137/540

(57) ABSTRACT

A constant flow valve is provided including a housing having a central flow passageway. The housing further includes an inlet portion, a cylindrical body portion, a frusto-conical valve portion, and an outlet portion. An obstruction plate is positioned within the housing so as to be longitudinally moveable upon a guide rod. The obstruction plate is biased by a tension and/or compression spring for biasing the obstruction plate axially towards the inlet portion and away from the frusto-conical valve portion. Preferably both a tension spring and compression spring exert force against the obstruction plate in opposition to the force exerted by air flowing into the inlet and through the central flow passageway. This mains a constant flow rate due to increased pressure differential causing the obstruction plate to move axially into the frusto-conical valve portion. Preferably, the constant flow valve includes means for adjusting the biasing means.

### RELATED APPLICATIONS

This application is a continuation-in-part application of pending U.S. application Ser. No. 11/799,410, filed May 1, 2007.

### BACKGROUND OF THE INVENTION

The present invention relates to automatic flow control valves for maintaining a desired output flow in response to a varying pressure differential across the valve. More particularly, the present invention relates to mechanical constant flow valves in the field of heating and ventilating for maintaining a constant flow through air ducts regardless of changes in upstream pressure variations. This constant flow of air is desirable to provide consistent heating or cooling without causing drafts or other undesirable air currents.

The output flow rate (Q) of a valve is a function of the effective area (A) of the ports of the valve, the fluid pressure differential across the valve (Δp) and the shape of the flow path through the valve (s). The relationship of each of these factors is generally reflected by the equation Q=As(Δp^{1/2}). Automatic flow control valves typically maintain a constant flow rate Q by modifying the area A of the ports inversely to a change in the pressure differential Δp across the valve. For example, flow adjustment valves may have fixed area input and output conduits, but an adjustable flowpath area therebetween. In response to an increase in the pressure differential across the valve, an occluding element may partially block an internal port to thus reduce the effective area through the valve. The dimensions of the valve are carefully controlled to ensure that the occluding element reduces the effective area through the valve in response to an increase in pressure differential in a manner to maintain a constant output flow rate.

An example of a constant flow rate valve for air ducts is described in my earlier U.S. Pat. No. 3,763,884. This patent describes a constant flow rate valve which automatically and mechanically senses the variations in upstream pressure to automatically change the cross-sectional area of the valve. The valve includes a specially shaped progressively decreasing cross-section which becomes increasingly obstructed by a restricter plate upon an increase in pressure differential. The cross-section decreases longitudinally along the axial length according to the relationship of [(A₁÷Aₓ)^{x}−1] wherein A₁ is the cross-sectional area of the inlet and Aₓ is the open cross-sectional area. Unfortunately, this equation results in a curved valve portion which is extremely difficult and expensive to manufacture. Moreover, it has been found that this curved structure does not accurately provide a constant flow.

Many additional attempts have been made for providing constant flow valves including those described in U.S. Pat. No. 3,037,528; U.S. Pat. No. 3,073,350; and U.S. Pat. No. 3,276,480. Each of these patents show valves in which fluid pressure acts on a restricting member to displace it against a spring to reduce cross-sectional area of the passageway through which air flows. The reduction in cross-sectional area maintains a constant volume of air through the flow valve. Unfortunately, each of these patents disclose flow control valves suffering from structural deficiencies such as being unjustifiably costly, complicated or ineffectual.

There is therefore a significant need for an improved flow valve which provided constant volume.

It would be desirable if the constant flow valve were passive, in other words did not require an electronic control apparatus for controlling flow.

It further would be advantageous if the constant flow valve was lightweight, simple and inexpensive to manufacture and easy to install.

### SUMMARY OF THE INVENTION

Briefly, in accordance with the invention, I provide an improved constant flow valve for air ducts. Advantageously, the constant flow valve is fully automated and mechanically responsive to varying pressure differentials across the valve to provide a constant flow rate. No electronic controls, power supply or complicated control system is employed.

The flow valve of the present invention includes a housing having a central flow passageway. The central flow passageway extends to form a longitudinal axis. The housing further includes an inlet portion for connection to a duct system and for receipt of air, and an outlet portion for connection to a duct system and for discharging air back into the duct network. Between the inlet and outlet, the housing includes a body portion and a frusto-conical valve portion. The body portion of the housing is substantially cylindrical and has a diameter greater than the diameter of the inlet portion. To connect the cylindrical body portion to the smaller diameter inlet portion, the hollow housing includes an adapter for expanding the cross-section of the flow valve's housing at the inlet portion to the housing's cylindrical body portion. Meanwhile, the housing's valve portion is frusto-conically shaped for connecting the large diameter cylindrical body portion to the smaller diameter outlet portion. As understood by those skilled in the art, by being frustoconically shaped, the valve portion has the shape of a cone with the narrow tip of the cone removed to form a parallel top and bottom. In practice, frusto-conical valve portion will have a progressively decreasing cross-section until connecting to the outlet portion which will typically have a cross-section substantially the same as the housing's inlet portion.

The frusto-conical, also often referred to as a frustum, shaped valve portion has a circular cross-section and a diameter “y” which will linearly decrease along its longitudinal length “x” from the cylindrical body portion to the housing's outlet portion. Since the diameter will decrease linearly, the relationship of the valve portion's diameter to its length can be represented by the equation y=kx where k is a constant.

The automated mechanical constant flow valve of the present invention further includes an obstruction plate positioned within the hollow housing's central flow passageway. The obstruction plate is circular with its face perpendicular to the housing's longitudinal axis and thus positioned to obstruct fluid flow through the housing's central passageway. Furthermore, the circular obstruction plate is positioned centrally and is moveable longitudinally within the cylindrical body portion and frusto-conical valve portion of the flow valve's housing. To this end, preferably the flow valve includes a guide rod coincident with the housing's longitudinal axis and the circular obstruction plate includes a central hole for slidable receipt of the guide rod.

The flow valve further includes a biasing means constructed to increase its biasing force as the obstructing member is displaced a distance x from the inlet portion into the progressively decreasing cross-section of the frusto-conical valve portion so as to automatically regulate the area of fluid flow and thereby keep a fluid flow substantially constant regardless of the pressure differential across the flow valve. The biasing means may include one or more linear tension and/or compression springs for biasing the obstruction plate toward the inlet portion of the housing. Preferably the biasing means includes a first tension spring which engages the obstruction plate and exerts a force increasing with the distance the circular obstruction plate moves away from the inlet portion. In additional embodiments, the biasing means includes a tension spring and a compression spring which engage the obstruction plate for exerting a force increasing with the distance the circular obstruction plate moves from said inlet portion. Preferably, the compression spring does not engage the circular obstruction plate until air flow has increased so as to move said circular obstruction plate a predetermined distance into said frusto-conical valve portion. For this construction, the compression spring does not exert force upon the obstruction plate at low flow rates, but does provide additional spring force when air flow has increased above a predetermined value and the obstruction plate has been forced into the frusto-conical portion of the flow valve. The compression spring provides additional spring force to maintain the obstruction plate in a desired position within the frusto-conical portion of the flow valve when otherwise the force exerted by the tension spring would not suffice.

In preferred embodiments, the constant flow valve includes an alignment rod longitudinally extending within the central housing parallel but centrally offset from the flow valve's guide rod. In addition, the obstruction plate includes a hole offset from the obstruction plate's center for slidable receipt of the alignment rod. In practice, the alignment rod and corresponding hole within the circular obstruction plate are constructed to prevent the circular obstruction plate from undesirable rotation or vibration within the valve's housing. In still an additional preferred embodiment, the constant flow valve includes means for adjusting the properties of the biasing spring. A preferred construction includes a means for adjusting the functional length of the linear spring so as to increase or decrease the spring rate so as to vary the desired flow rate within the constant flow valve.

It is thus an object of the present invention to provide an automated mechanical constant flow valve for maintaining constant air flow through an air duct.

It is still another object of the present invention to provide an automated mechanical constant flow valve which does not require operation of an electrical control system.

It is still an additional object of the present invention to provide an automated mechanical constant flow valve which is simple to manufacture, inexpensive, and easy to operate.

These and other and more specific objects and advantages of the invention will be apparent to those skilled in the art from the following detailed description taken in conjunction with the drawings.

### BRIEF DESCRIPTION OF THE DRAWINGS

FIG. 1 is an exterior perspective view of the constant flow valve of the present invention;

FIG. 2 is a partially exploded view of the constant flow valve of the present invention;

FIG. 3 is an exploded perspective view of the constant flow valve of the present invention illustrating hidden features;

FIG. 4 is a side cross-sectional view of the constant flow valve of the present invention;

FIG. 5 is a side cut-away view of the constant flow valve of the present invention illustrating operation of the biasing means due to increased air flow through the constant flow valve;

FIG. 6 is a side cut-away view of the constant flow valve of the present invention illustrating still an additional increase in pressure differential across the valve due to increased air flow;

FIG. 7 is a side cut-away view of the constant flow valve of the present invention with the biasing means adjusted;

FIG. 8 is an exploded perspective view of a constant flow valve of the present invention illustrating hidden features including a tension spring and compression;

FIG. 9 is a side cut-away view of the constant flow valve of the present invention illustrating operation of the biasing means due to increased air flow through the constant flow valve; and

FIG. 10 is a side cut-away view of the constant flow valve of the present invention illustrating still an additional increase in pressure differential across the flow valve due to increased air flow so that the obstruction plate engages the compression spring.

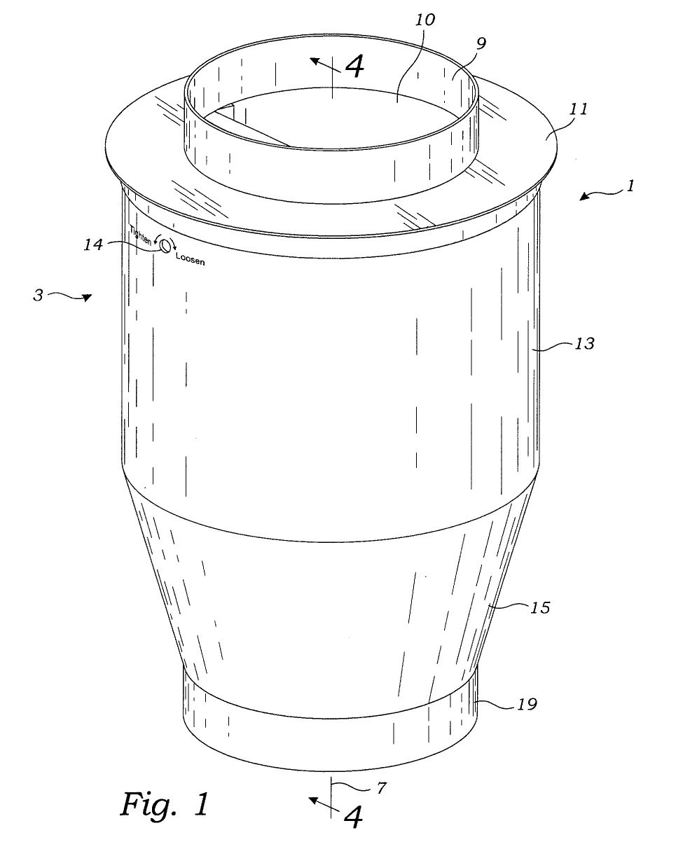

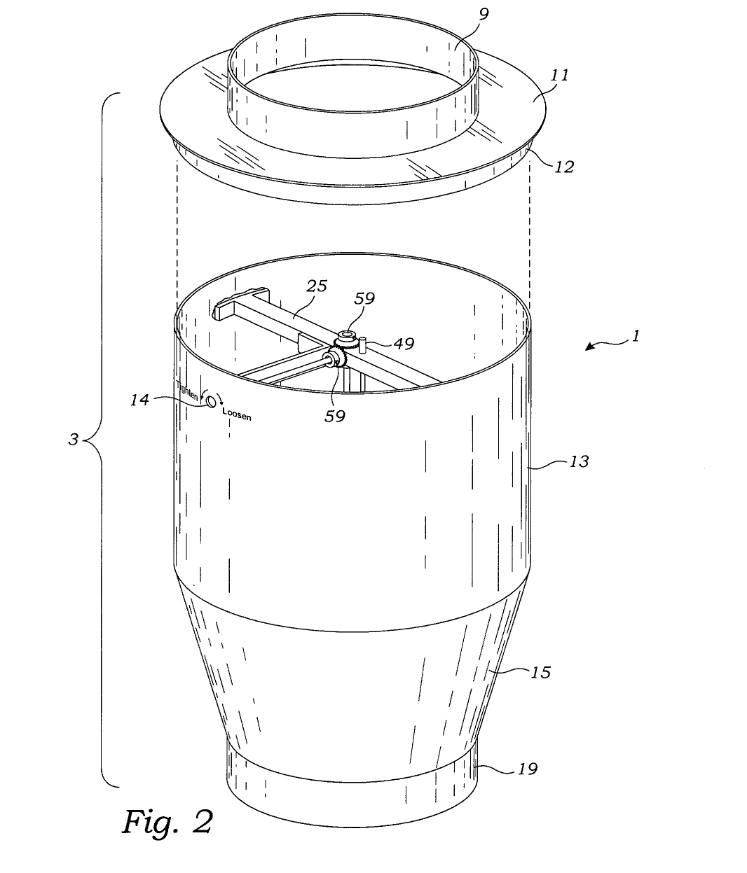

### DETAILED DESCRIPTION OF THE INVENTION

While the present invention is susceptible of embodiments in various forms, as shown in the drawings, hereinafter will be described the presently preferred embodiments of the invention with the understanding that the present disclosure is to be considered as an exemplification of the invention and it is not intended to limit the invention to the specific embodiments illustrated.

The constant flow valve 1 of the present invention includes an elongate housing 3 having a central flow passageway 5. The central flow passageway extends axially to define a longitudinal axis 7. The housing is constructed to include four definite portions including an inlet portion 9, a cylindrical body portion 13, a frusto-conical portion 15, and an outlet portion 19.

The inlet portion 9 may be constructed in various shapes so as to connect to an air duct. As shown in the drawings, the inlet 9 includes a circular opening 10 for the introduction of air from an air duct. Air is introduced into the opening 10 for passage through the constant flow valve's central flow passageway 5 until expelled through the outlet portion's exit 21. The housing's body portion 13 and frusto-conical portion 15 are positioned between the inlet portion and outlet portion. The body portion is cylindrical and has a diameter significantly greater than the diameter of the inlet portion. To connect the cylindrical body portion to the smaller diameter inlet portion, the housing includes an adapter ring 11. The adapter ring may take various forms as could be constructed by one skilled in the art. As shown in the drawings, the adapter is formed in one piece with the inlet portion and consists of a radially extending ring and an axially extending circular flange 12 which is sized to form a press-fit arrangement with the cylindrical body portion 13.

The housing's valve portion 15 is frusto-conically shaped. As illustrated in the drawings, the base of the frusto-conical shape of the valve portion 15 engages the cylindrical body portion 13 so as to have a linearly decreasing cross-section until mating to the housing's outlet portion 19. As a result of its linear decrease in diameter, the valve portion's diameter to its length can be represented by the equation y=kx where k is a constant.

The constant flow valve 1 of the present invention further includes an obstruction plate 31 positioned to obstruct flow within the flow valve central flow passageway 5. The obstruction plate is preferably round and has a central hole 33 for providing means to moveably mount the obstruction plate 31 within the housing 3 for allowing axial movement of the obstruction plate along the flow valve's longitudinal axis 7. The means for mounting the obstruction plate within the housing includes a guide rod 43 which is positioned along the flow valve's longitudinal axis and which is supported in place by support beams 25. The support beams include central holes for acceptance of the guide rod 43. As explained in greater detail below, in a preferred embodiment the flow valve 1 further includes an alignment rod 47 which extends parallel to the guide rod 43. The alignment rod is offset from the central flow passageway's center and extends through an offset hole 35 formed in the obstruction plate 31. The alignment rod 47 prevents unwanted rotation of the obstruction plate 31, though other constructions for preventing rotation of the obstruction plate can be devised by those skilled in the art without undue experimentation. Furthermore, the alignment rod may be rotateably or non-rotateably affixed to the support means 25 by various constructions. As shown in the drawings, simply providing holes in the support beams and capping the alignment rod with caps 49 provides an adequate construction.

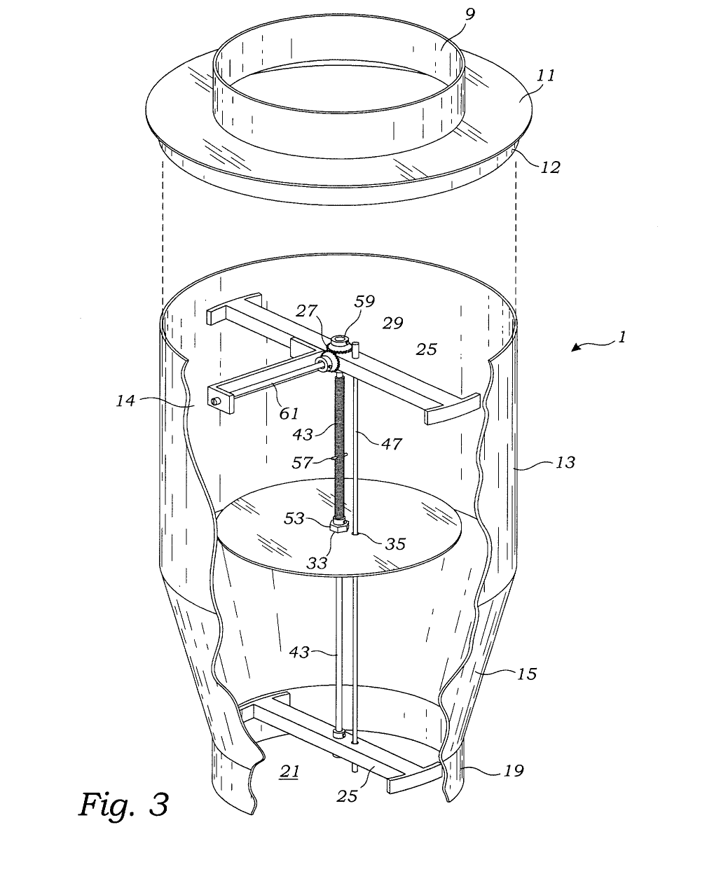

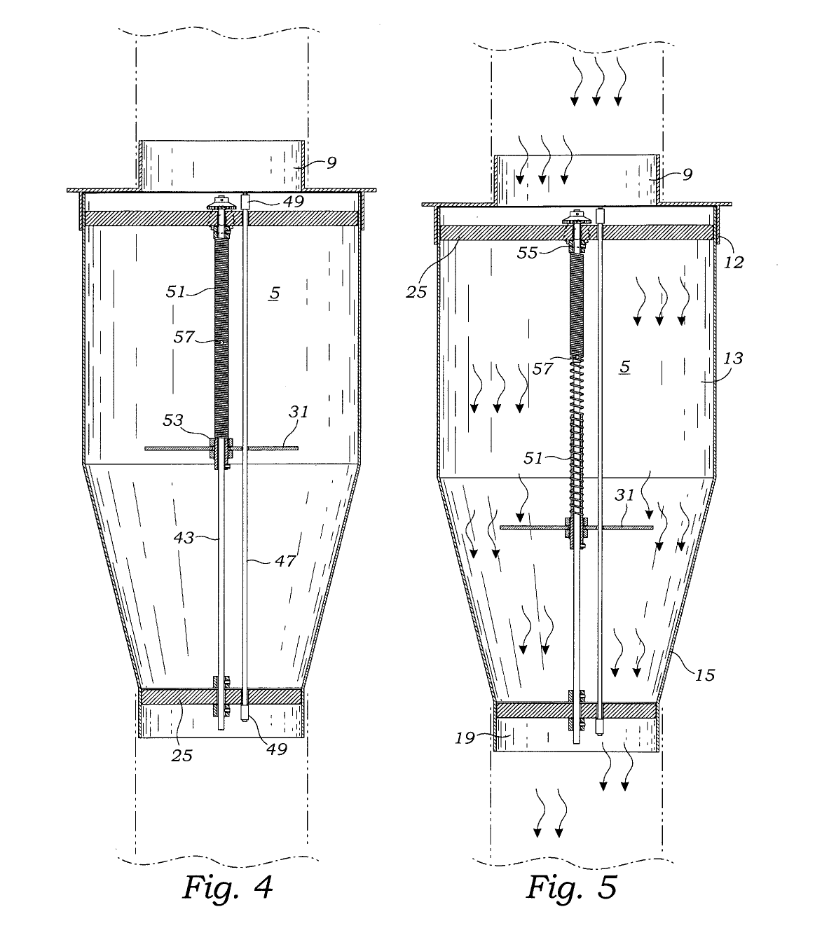

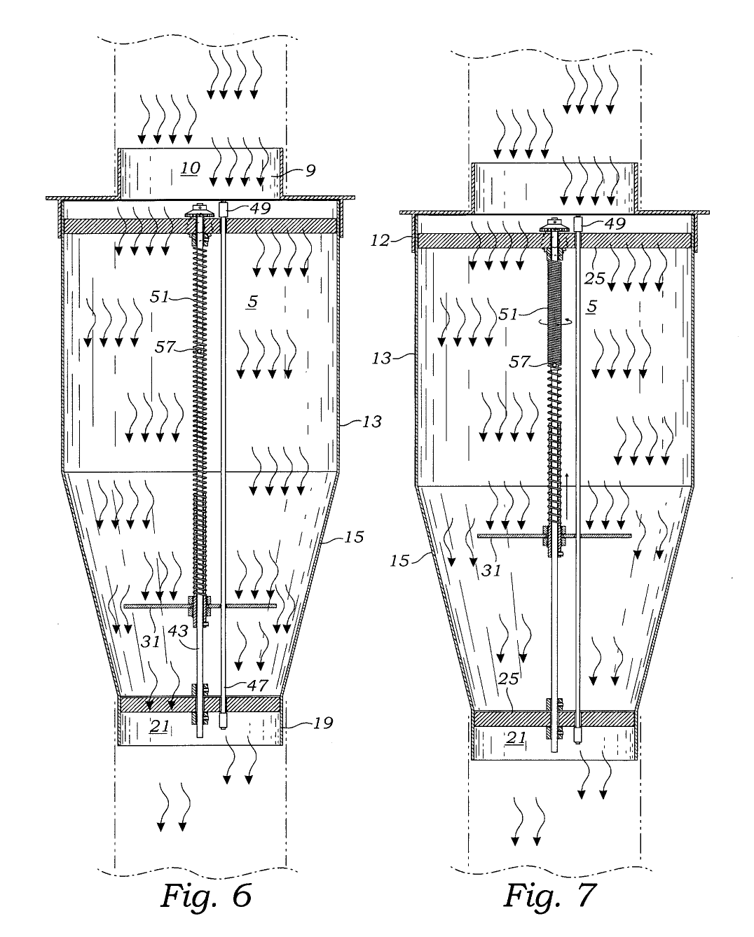

The constant flow valve 1 of the present invention further includes a biasing means for biasing the obstruction plate axially towards the inlet portion 9 against the force of air entering the inlet opening 10. The preferred biasing means includes the use of a spring which can be utilized in either compression or tension. As shown in FIGS. 3-7, a preferred biasing means takes the form of a spring 51 which affixes at one end to the obstruction plate 31 and at the other end to a support beam 25 positioned close to the flow valve's inlet portion 9. As shown in FIG. 4, in the absence of any air flow through the flow valve 1, the spring 51 will reside neither in tension or compression. However, as shown in FIG. 5, with the introduction of air from an air duct system passing from the inlet opening 10 downstream through the central flow passageway 5 and expelled through the exit opening 21 will cause the spring 51 to be in tension as the obstruction plate 31 is forced downstream due to the pressure differential across the flow valve. Since the area of the obstruction plate 31 is fixed, an increase in upstream pressure will produce a force which will cause the spring to stretch in tension until the force of the spring balances the force of the air on the plate. As a result of the decreased cross-sectional area of the passageway between the plate 31 and sidewalls 17 of the frusto-conically shaped valve portion, the desired volume of air is provided. Thus, for a decrease in the upstream pressure, the force on the plate 31 will decrease and the spring 51 will contract to move the obstruction plate 31 to provide an increase in cross-sectional area for air flow so as to provide a constant flow volume.

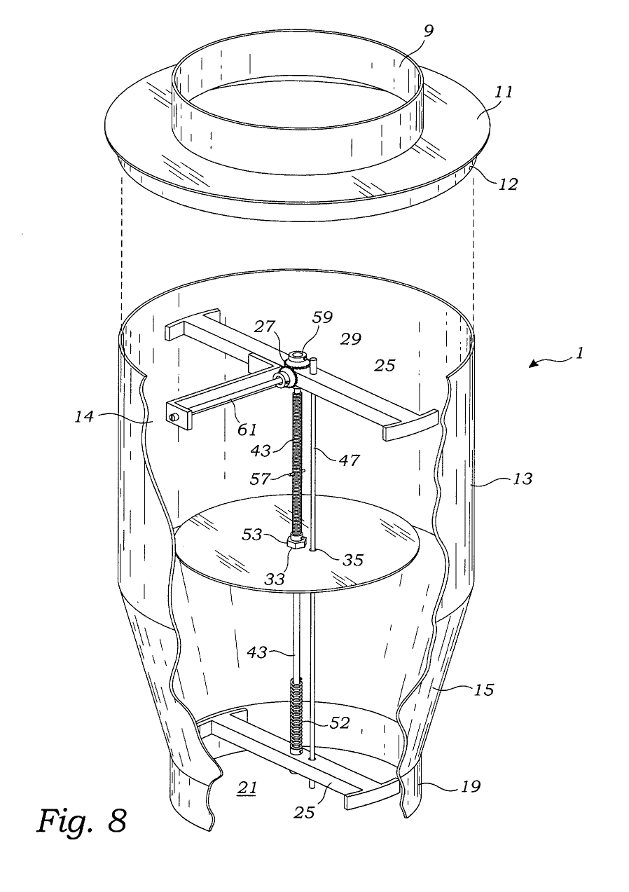

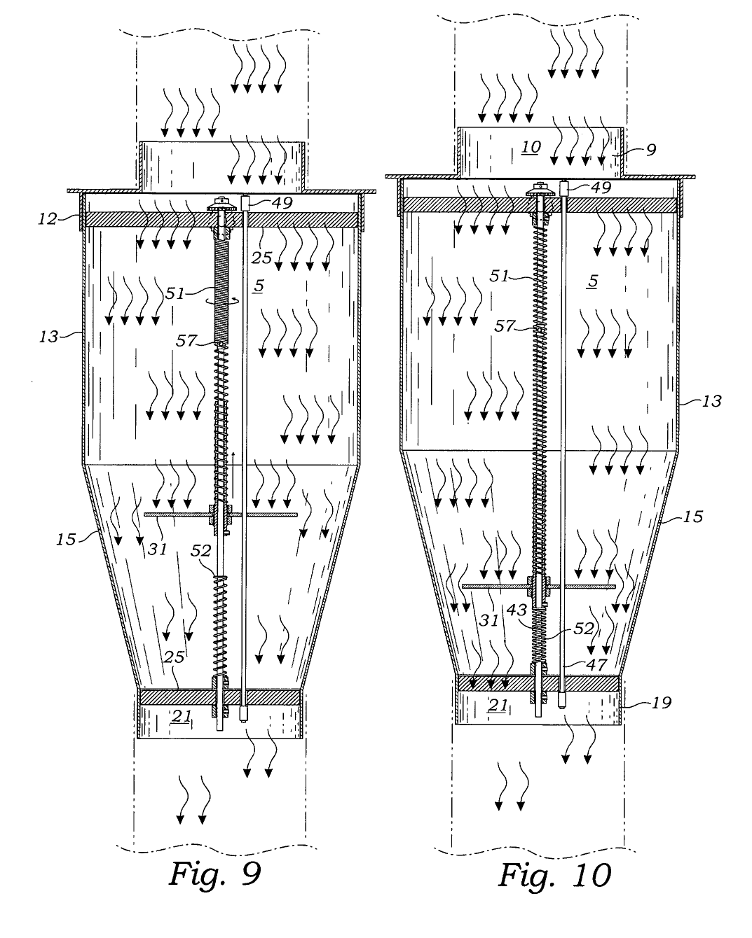

In an additional embodiment illustrated in FIGS. 8-10, the biasing means includes both a tension spring 51 and a compression spring 52. The tension spring 51 affixes at one end to the obstruction plate 31 and at the other end to the support beam 25 positioned close to the flow valve's inlet portion 9. In the absence of any air flow through the flow valve 1, the spring 51 will reside neither in tension or compression. Meanwhile, preferably the compression spring 52 affixes at one end to a support beam 25 positioned close to the flow valve's outlet portion 19. The compression spring 52 may engage the obstruction plate 31 when there is no air flow or pressure differential across the flow valve. However, in a preferred embodiment illustrated in FIGS. 8 & 9, the compression spring 52 does not engage the obstruction plate 31 until air flow has increased so as to move the obstruction plate into a desired distance into the frusto-conical valve portion 15. For this embodiment, as illustrated in FIG. 10, the compression spring 52 provides additional (non-linear) spring force to bias the obstruction plate toward the inlet portion when air flow has increased above a predetermined value.

Preferably, the constant flow valve 1 includes a means for adjusting the spring properties. As illustrated in the Figures, the preferred constant flow valve 1 includes a pin 57 which projects radially from the guide rod 43 and the guide rod is manually rotatable by the addition of bevel gears 59 and torque rod 61. The torque rod 61 preferably extends radially from the bevel gears to the edge of the cylindrical body portion where an adjustment hole 14 is located. Furthermore, the torque rod 61 preferably includes a slot for permitting rotation of the torque rod with a screwdriver or the like.

As a result of the spring being rotationally affixed in place within the flow valve's housing 3, due to engaging the non-rotatable obstruction plate 31 and non-rotatable support beam 25, while the guide rod 43 is rotatable it allows the pin 57 to threadably move longitudinally along the length of the spring 51. Movement of the pin longitudinally along the length of the spring allows one to lengthen or shorten the active portion of the spring which extends from the pin 57 to the obstruction plate 31. Specifically, a person utilizing a screwdriver or the like can rotate the torque rod 61 to rotate its corresponding bevel gear 59. As illustrated in FIG. 7, rotation of the first bevel gear causes a second bevel gear positioned on the end of the guide rod 43 to rotate. In turn, rotation of the guide rod causes the pin 57 to rotate along the thread of the non-rotating spring 51 to lengthen or shorten the length of spring between the pin and obstruction plate.

In practice, once the constant flow valve has been placed within a duct system, an instrument is inserted into the duct system to sense flow rate. The torque rod 61 is rotated using a screwdriver or other suitable tool to adjust the spring rate to match the desired flow rate.

Various modifications of the invention may be made without departing from the spirit and scope of the invention. For example, the flow valve has been described and illustrated with a tension spring having adjustable spring properties. However, the properties of the compression spring also may be adjustable, or alternatively may be adjustable, by providing a similar pin projecting through the compression spring coils, bevel gear and torque rod construction as described for the tension spring. In addition, the constant flow valve 1 of the present invention may be constructed of various sizes and dimensions. However, an example of an acceptable constant flow valve includes inlets and outlets having 7 inch diameters, an obstruction plate also having a 7 inch diameter, and a cylindrical body portion having a 10 inch diameter. The longitudinal length of the cylindrical body portion and frusto-conical valve portion can vary greatly. However, this preferred embodiment includes a cylindrical body portion having a longitudinal length of approximately 8 inches and a frusto-conical valve portion having a longitudinal length of about 5½ inches. As understood by those skilled in the art, the spring coefficients and lengths of the tension and compression springs will vary greatly due to a desired flow rate and acceptable springs can be selected by those skilled in the art.

Still additional modifications can be made without departing from the spirit and scope of the invention. Therefore, it is not intended that the invention be limited except by the following claims.

Having described my invention in such terms so as to enable persons skilled in the art to understand the invention, recreate the invention and practice it, and having identified the presently preferred embodiments thereof, I claim:

1. An automated mechanical constant flow valve for air ducts for maintaining a predetermined constant output flow rate in response to a varying pressure differential across the valve comprising:
a hollow housing including a central flow passage for communicating air flow along a longitudinal axis, the hollow housing including an inlet portion for engaging an air supply duct, a substantially cylindrical body portion downstream of said inlet portion and having a diameter greater than said inlet portion, an adapter portion for connecting the small diameter inlet portion to said larger diameter cylindrical body portion; a frusto-conical valve portion downstream and adjacent to said body portion, and an outlet portion for engaging an air discharge duct;
said frusto-conical valve portion having a circular cross-section and a diameter “y” linearly decreasing along its longitudinal length “x” according to the equation y=kx so as to have a large diameter inlet for engaging said housing's body portion and a small diameter outlet for engaging said outlet portion;
a circular obstruction plate longitudinally moveable within said frusto-conical valve portion, said plate having a diameter; and
a biasing means for biasing said circular obstruction plate longitudinally toward said inlet portion so as to automatically regulate and maintain a substantially constant air flow rate through said housing for a predetermined pressure range at said inlet portion, said biasing means including a tension spring engaging said obstruction plate for exerting a force increasing with the distance the circular obstruction plate moves from said inlet portion and said biasing means including a compression spring engaging said obstruction plate for exerting a force increasing with the distance the circular obstruction plate moves from said inlet portion, said compression spring not engaging said circular obstruction plate until air flow has increased so as to move said circular obstruction plate a predetermined distance into said frusto-conical valve portion so as to provide additional spring force than said tension spring when air flow has increased above a predetermined value.

2. The automated mechanical constant flow valve for air ducts of claim 1 wherein said biasing means is a linear spring having a plurality of coiled threads, and the automated mechanical constant flow valve includes adjustment means for adjusting the rate of linear spring to provide a constant flow rate through said housing.

3. The automated mechanical constant flow valve for air ducts of claim 2 further comprising:
a rotatable guide rod extending centrally and longitudinally within said housing, said obstruction plate including a central guide hole for slidable receipt of said guide rod, and said coil spring and said obstruction plate concentrically slidably mounted upon said guide rod;
a pin extending radially from said guide rod through threads of said coil spring; and
said adjustment means includes an adjustment hole formed in the sidewall of said housing, a torque rod extending radially from said guide rod to said adjustment hole, and pair of bevel gears connecting said torque rod to said guide rod wherein rotation of said torque rod causes said guide rod to rotate, which causes said pin to rotate through said spring threads to adjust said spring rate.

4. The automated mechanical constant flow valve for air ducts of claim 3 further comprising a longitudinally extending and centrally offset rotational restricting rod, said obstruction plate including an offset hole for slidable receipt of said rotational restricting rod, said rotational restricting rod inhibiting rotation of said obstruction plate about said guide rod.

5. The automated mechanical constant flow valve for air ducts of claim 1 further comprising a longitudinally extending and centrally positioned guide rod and a longitudinally extending and centrally offset rotational restricting rod, said obstruction plate including a central guide hole for slidable receipt of said guide rod and an offset hole for slidable receipt of said rotational restricting rod, said rotational restricting rod inhibiting rotation of said obstruction plate about said guide rod.
